(19) United States
(12) Patent Application Publication
(10) Pub. No.: US 2011/0316763 A1
(43) Pub. Date: Dec. 29, 2011

(54) HEAD-MOUNTED DISPLAY APPARATUS, IMAGE CONTROL METHOD AND IMAGE CONTROL PROGRAM

(75) Inventor: Yuki YADA, Kuwana-shi (JP)

(73) Assignee: BROTHER KOGYO KABUSHIKI KAISHA, NAGOYA-SHI (JP)

(21) Appl. No.: 13/222,856

(22) Filed: Aug. 31, 2011

Related U.S. Application Data
(63) Continuation-in-part of application No. PCT/JP2010/053058, filed on Feb. 26, 2010.

(30) Foreign Application Priority Data
Mar. 5, 2009 (JP) 2009-051644

(51) Int. Cl. G09G 5/00; G06K 9/00

(52) U.S. Cl. 345/8; 382/162

(57) ABSTRACT

A head-mounted display apparatus which is mountable around a head of a user and configured to allow the user to visually recognize an information image based on image information together with an outside scene image is provided. The apparatus includes an imaging unit which takes the outside scene image, a low frequency region extraction unit which extracts a low frequency region having a space frequency component equal to or smaller than a predetermined space frequency, a color phase recognition unit which recognizes a predetermined color phase in the outside scene image, an imaging frame determination unit which determines an imaging frame based on an image portion which has the predetermined color phase and has a predetermined shape, within the low frequency region, and an image extraction unit which extracts an image within the imaging frame from the outside scene image, and store the extracted image.

This is a Continuation-in-Part of International Patent Application No. PCT/JP2010/053058 filed Feb. 26, 2010, which claims the benefit of Japanese Patent Application No. 2009-051644 filed Mar. 5, 2009. The disclosures of the prior applications are hereby incorporated by reference herein in their entireties.

### TECHNICAL FIELD

This disclosure relates to a head-mounted display apparatus (hereinafter, referred to as “HMD”) that is mountable around a head of a user and allows the user to take an outside scene image while visually recognizing an information image based on image light generated from image information and the outside scene image based on outside light at the same time.

### BACKGROUND

There has been suggested an HMD that is mountable around a head of a user, takes an outside scene image and performs image processing for the taken image, based on a position or a shape of a finger of the user seen within an imaging range.

By using such HMD, the user can take an image without touching a camera and using an operation unit such as a remote controller.

However, when the user uses the HMD, it is necessary for the user to perform a focusing operation on the finger at least one time. Therefore, it is necessary for the user to perform two operations, i.e., an operation of focusing on the outside scene and an operation of focusing on the finger, so that it takes more time to perform the focusing operations.

### SUMMARY

In view of the above, an aspect of this disclosure provides a head-mounted display apparatus (HMD) that allows a user to take an image without operating an imaging unit and requires less time for a focusing operation.

According to an aspect of this disclosure, there is provided a head-mounted display which is mountable around a head of a user and which is configured to allow the user to visually recognize an information image based on image light generated from image information together with an outside scene image based on outside light. The head-mounted display apparatus includes: an imaging unit configured to take the outside scene image based on the outside light; a low frequency region extraction unit configured to extract, from the outside scene image, a low frequency region having a space frequency characteristics which has a space frequency component equal to or smaller than a predetermined space frequency; a color phase recognition unit configured to recognize a predetermined color phase in the outside scene image taken by the imaging unit; an imaging frame determination unit configured to determine an imaging frame indicating an image cutout range, based on an image portion which has the predetermined color phase recognized by the color phase recognition unit and has a predetermined shape, within the low frequency region extracted by the low frequency region extraction unit; and an image extraction unit configured to extract an image within the imaging frame determined by the imaging frame determination unit from the outside scene image taken by the imaging unit, and store the extracted image.

According to another aspect of this disclosure, there is provided an image control method for a head-mounted display apparatus mountable around a head of a user and configured to allow the user to visually recognize an information image based on image light generated from image information together with an outside scene image based on outside light. The method includes: taking the outside scene image; extracting, from the taken outside scene image, a low frequency region having a space frequency characteristics which has a space frequency component equal to or smaller than a predetermined space frequency; recognizing a predetermined color phase in the taken outside scene image; determining an imaging frame indicating an image cutout range, based on an image portion which has the predetermined color phase and has a predetermined shape, within the extracted low frequency region; and extracting an image within the determined imaging frame from the taken outside scene image, and storing the extracted image.

According to a further aspect of this disclosure, there is provided a non-transitory computer-readable medium having a computer program stored thereon and readable by a computer included in a head-mounted display apparatus mountable around a head of a user and configured to allow the user to visually recognize an information image based on image light generated from image information together with an outside scene image based on outside light, the computer program, when executed by the computer, causing the computer to perform operations including: taking the outside scene image; extracting, from the taken outside scene image, a low frequency region having a space frequency characteristics which has a space frequency component equal to or smaller than a predetermined space frequency; recognizing a predetermined color phase in the taken outside scene image; determining an imaging frame indicating an image cutout range, based on an image portion which has the predetermined color phase and has a predetermined shape, within the extracted low frequency region; and extracting an image within the determined imaging frame from the taken outside scene image, and storing the extracted image.

### BRIEF DESCRIPTION OF THE DRAWINGS

The above and other aspects of this disclosure will become more apparent and more readily appreciated from the following description of illustrative embodiments of this disclosure taken in conjunction with the attached drawings,

FIG. 1 shows an outer appearance of a head-mounted display apparatus (HMD) according to a first illustrative embodiment of this disclosure;

FIGS. 2 (2A and 2B) shows electrical and optical configurations of the HMD;

FIG. 3A is a flow chart showing a main process;

FIG. 3B is a flow chart showing a process for detecting a blur region;

FIG. 4A shows an outside scene that is taken by a CCD 5 and is visually recognized by a user P;

FIG. 4B shows a state where a variety of content images are displayed in a display range of the HMD 1;

FIG. 4C shows an imaging frame determination process;

FIG. 4D shows an operation of cutting out an image within an imaging frame FR;

FIG. 5 shows extraction of a blur region;

FIG. 6 shows a predetermined shape SH;

FIG. 7 shows a method of configuring an imaging frame; and

FIG. 8 is a flow chart showing a process according to a second illustrative embodiment, which corresponds to the processes of SA3 to SA5 of FIG. 3A.

### DETAILED DESCRIPTION

### First Illustrative Embodiment

Hereinafter, a first illustrative embodiment of this disclosure will be described with reference to the drawings.

A retina scanning display is an example of a head-mounted display apparatus. The head-mounted display apparatus is referred to as “HMD”. The HMD is configured to be mounted on a head of a user and in the vicinity thereof, guide image light to an eye of the user and scan the same on a retina of the user in a two-dimensional direction, thereby allowing the user to visually recognize an image corresponding to content information. Herein, the image corresponding to the content information is referred to as “content image.”

In the meantime, the “visual recognition” has a meaning including two modes, i.e., a mode that the image light is scanned in the two-dimensional direction on a retina of a user and the user thus recognizes an image, and a mode that an image is displayed on a display panel and the user thus recognizes an image based on the image light from the image on the display panel.

In the below, when the term “display” is used, this means an operation of allowing the user to recognize the image based on the image light. That is, in this sense, it can be said that, in the above both modes, the image is displayed based on the image light.

The retina scanning display of this illustrative embodiment includes an imaging unit that can take an outside scene. Thus, the person who wears the HMD 1 (retina scanning display) on his head is referred to as a “user.”

[Outer Appearance of HMD]

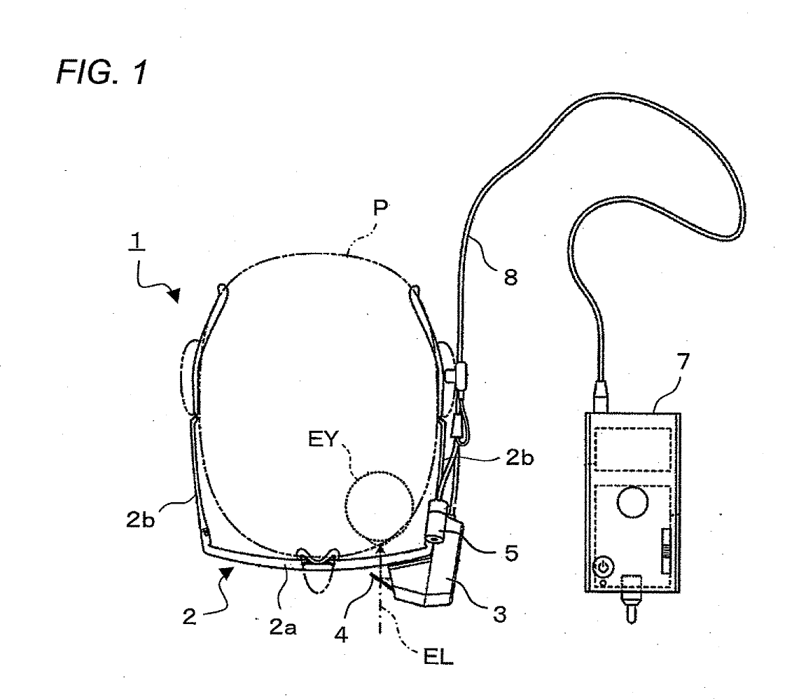

As shown in FIG. 1, the HMD 1 includes a frame member 2, an image display unit 3, a half mirror 4, a CCD (Charge Coupled Devices, an example of an imaging unit) 5 and a system box 7.

The HMD 1 is a retina scanning display that displays, as an image, a variety of content information such as a document file, an image file, a moving picture file and the like such that a user P can visually recognize the same while the user P wears the frame member 2 on a head of the user. In this illustrative embodiment, the content image also includes images that are used to take an image, such as a marker indicating a focus position, an imaging frame and the like.

As shown in FIG. 1, the frame member 2 has a frame shape of eyeglasses and includes a front part 2a and a pair of temple parts 2b.

As shown in FIG. 1, the image display unit 3 is attached to the left temple part 2b, when seen from the user P. The image display unit 3 scans image light two-dimensionally, thereby generating image light for displaying the content image.

As shown in FIG. 1, the half mirror 4 is provided to the image display unit 3. The half mirror 4 reflects the image light generated from the image display unit 3, thereby guiding the same to the retina of the eye EY of the user P. The half mirror 4 is semi-transparent, so that outside light EL transmits the half mirror. Therefore, when the user P wears the HMD 1, the user can visually recognize the content image and the outside scene at the same time.

The image display unit 3 reflects the image light at a predetermined position of the half mirror 4, based on data stored in a ROM that will be described later, thereby guiding the same to the retina. Based on the reflection range and the mount position of the half mirror 4, a range, a position and a direction within which the user P visually recognizes the content image are determined.

The CCD 5 is attached on the image display unit 3,

An optical axis of the CCD 5 is set such that, when the image light is reflected by the half mirror and is guided onto the retina of the user P, the optical axis substantially matches a direction along which the image light is incident onto the retina. Since the optical axis of the CCD 5 is set in that manner, the CCD 5 can take the outside scene in a range that substantially matches a range within which the user P visually recognizes the content image.

The system box 7 is connected to the image display unit 3 via a transmission cable 8. The system box 7 generally controls the operations of the HMD 1 and generates the image light for generating the content image. The transmission cable 8 has an optical fiber and a cable for transmitting various signals.

[Electrical Configuration of HMD]

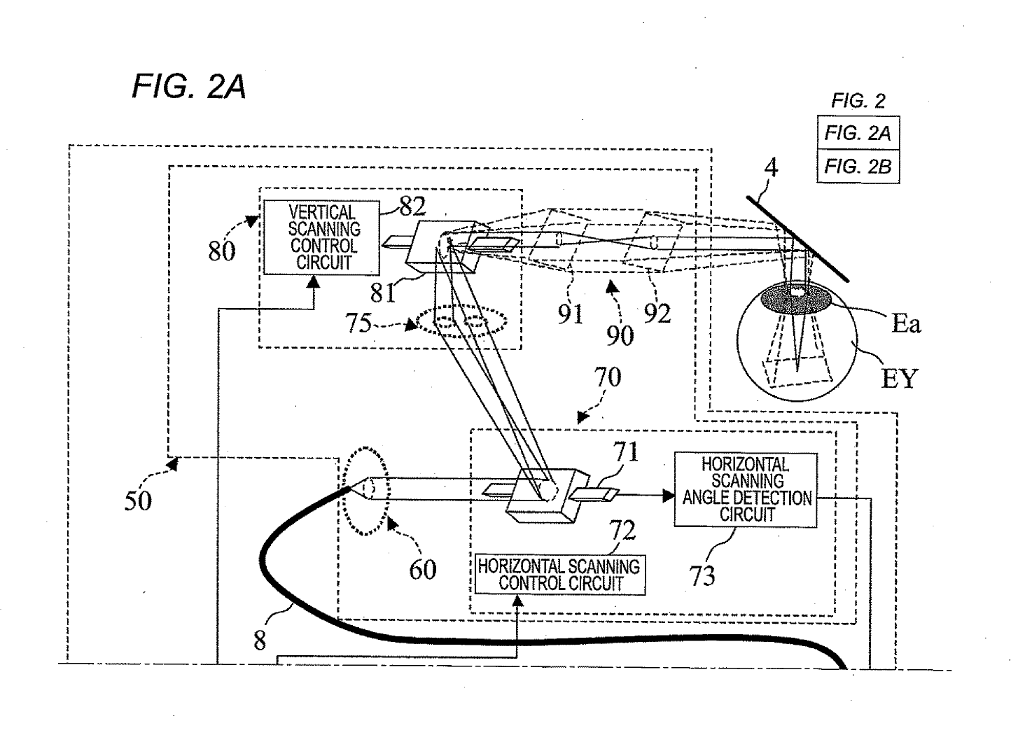

An electrical configuration of the HMD 1 of this illustrative embodiment is described with reference to FIG. 2.

As shown in FIG. 2, the HMD 1 includes a general control unit 10 that generally controls the operations of the HMD 1, a light generating unit 20 that generates image light of a content image, and a light scanning unit 50 that scans the image light such that the content image is visually recognized by the user P. The general control unit 10 and the light generating unit 20 are embedded in the system box 7 and the light scanning unit 50 is embedded in the image display unit 3.

The general control unit 10 supplies image data to the light generating unit 20. Here, the image data is data indicating the content image that is visually recognized by the user P. The light generating unit 20 generates image light, based on the image data supplied from the general control unit 20, and supplies the same to the light scanning unit 50. The light scanning unit 50 scans the image light generated by the light generating unit 20 two-dimensionally and thus displays the content image, thereby allowing the user P to visually recognize the same.

The general control unit 10 has a CPU (central processing unit) 12, a ROM (Read Only Memory) 13, a RAM (Random Access Memory) 14, a VRAM (Video Random Access Memory) 15 and a bus 16.

The CPU 12 is a calculation processing unit that executes various information processing programs stored in the ROM 13, thereby realizing a variety of functions of the HMD 1. The ROM 13 is configured by a flash memory that is a non-volatile memory. The ROM 13 stores the various information processing programs that are executed by the CPU 12, such as information processing programs for operating the light generating unit 20, the light scanning unit 50 and the like when performing the controls of play, stop, fast forwarding, fast rewinding and the like of the content to be displayed by the HMD 1. The ROM 13 also stores the image data such as a marker and an imaging frame, and a plurality of tables that are referred to when the general control unit 10 performs the various display controls, and the like. The RAM 14 is an area that temporarily stores the various data such as image data. The VRAM 15 is an area that, when an image is displayed, the image to be displayed is temporarily drawn before the image is displayed. The CPU 12, the ROM 13, the RAM 14 and the VRAM 15 are respectively connected to the bus 16 for data communication and transmit and receive a variety of information via the bus 16. In this illustrative embodiment, the CPU 12 together with the ROM 13, the RAM 14 and the VRAM 15 configures a computer that controls the HMD 1.

The general control unit 10 is connected to a power supply switch SW and the CCD 5 of the HMD 1.

The light generating unit 20 has a signal processing circuit 21, a light source unit 30 and a light synthesis unit 40.

The image data is supplied from the general control unit 10 to the signal processing circuit 21. The signal processing circuit 21 generates image signals 22a to 22c of blue, green and red, which are elements for synthesizing an image, based on the supplied image data, and supplies the same to the light source unit 30. The signal processing circuit 21 supplies a horizontal driving signal 23 for driving a horizontal scanning unit 70 to the horizontal scanning unit 70 and supplies a vertical driving signal 24 for driving a vertical scanning unit 80 to the vertical scanning unit 80.

The light source unit 30 functions as an image light output unit that outputs image lights based on the three image signals 22a to 22c supplied from the signal processing circuit 21, respectively. The light source unit 30 includes a B laser 34 that generates a blue image light and a B laser driver 31 that drives the B laser 34, a G laser 35 that generates a green image light and a G laser driver 32 that drives the G laser 35, and a R laser 36 that generates a red image light and a R laser driver 33 that drives the R laser 36.

The light synthesis unit 40 is supplied with the three image lights that are output from the light source unit 30 and synthesizes the three image lights into one image light to generate arbitrary image light. The light synthesis unit 40 collimates the image lights incident from the light source unit 30 into parallel lights. The light synthesis unit 40 has collimator optical systems 41, 42, 43, dichroic mirrors 44, 45, 46 for synthesizing the collimated image lights and a coupling optical system 47 for guiding the synthesized image light to the transmission cable 8. The laser lights emitted from the respective lasers 34, 35, 36 are respectively made to be parallel lights by the collimator optical systems 41, 42, 43, which are then incident onto the dichroic mirrors 44, 45, 46. Then, the dichroic mirrors 44, 45, 46 selectively reflect or transmit the respective image lights with respect to wavelengths.

The light scanning unit 50 has a collimator optical system 60, the horizontal scanning unit 70, the vertical scanning unit 80 and relay optical systems 75, 90.

The collimator optical system 60 collimates the image light emitted through the transmission cable 8 into parallel light and guides the same to the horizontal scanning unit 70. The horizontal scanning unit 70 reciprocally scans the image light, which is collimated by the collimator optical system 60, in the horizontal direction so as to display an image. The vertical scanning unit 80 reciprocally scans the image light that is scanned in the horizontal direction by the horizontal scanning unit 70. The relay optical system 75 is provided between the horizontal scanning unit 70 and the vertical scanning unit 80 and guides the image light scanned by the horizontal scanning unit 70 to the vertical scanning unit 80. The relay optical system 90 emits the image light, which is scanned (two-dimensionally) in the horizontal and vertical directions, toward the pupil Ea of the eye EY.

The horizontal scanning unit 70 has a resonance-type deflection element 71, a horizontal scanning control circuit 72 and a horizontal scanning angle detection circuit 73.

The resonance-type deflection element 71 has a reflective surface for scanning the image light in the horizontal direction. The horizontal scanning control circuit 72 resonates the resonance-type deflection element 71, based on the horizontal driving signal 23 supplied from the signal processing circuit 21. The horizontal scanning angle detection circuit 73 detects an oscillation state of the reflective surface of the deflection element 71 such as oscillating range and oscillating frequency, based on a displacement signal output from the resonance-type deflection element 71. The horizontal scanning angle detection circuit 73 supplies a signal, which indicates of the detected oscillating state of the resonance-type deflection element 71, to the general control unit 10.

The relay optical system 75 relays the image light between the horizontal scanning unit 70 and the vertical scanning unit 80. The lights that are scanned in the horizontal direction by the resonance-type deflection element 71 are converged onto a deflection element 81 in the vertical scanning unit 80 by the relay optical system 75.

The vertical scanning unit 80 has the deflection element 81 and a vertical scanning control circuit 82.

The deflection element 81 scans the image light, which is guided by the relay optical system 75, in the vertical direction. The vertical scanning control circuit 82 oscillates the deflection element 81, based on the vertical driving signal 24 supplied from the signal processing circuit 21.

The image light, which is scanned in the horizontal direction by the resonance-type deflection element 71 and scanned in the vertical direction by the deflection element 81, is emitted toward the relay optical system 90, as scanning image light scanned two-dimensionally.

The image light that is scanned by the resonance-type deflection element 71 and the deflection element 81 is scanned by a predetermined scanning angle at a predetermined timing. That is, at one moment, the image light is a single one. It is noted that, in the below, the expression “the scanning image light is configured by a plurality of scanned image lights” is used for convenience. However, precisely, the scanning image light consists of single one image light at one moment.

The relay optical system 90 has lens systems 91, 92 having positive refractive force. The lens system 91 converts the respective image lights scanned by the resonance-type deflection element 71 and the deflection element 81 such that center lines of the image lights become substantially parallel with each other. The lens system 91 converges one time the respective image lights into a center position between the lens system 91 and the lens system 92. The respective image lights, which are converged to the center position one time, are diverged and supplied to the lens system 92.

The lens system 92 collimates the image lights supplied from the lens system 91. Then, the lens system 92 converts the respective image lights such that the center lines thereof are converged to the pupil Ea of the user.

The image lights supplied from the lens system 92 are reflected one time by the half mirror 4 and then converged to the pupil Ea of the user. By doing so, the user P can visually recognize the content image.

The general control unit 10 receives the signal based on the oscillating state of the resonance-type deflection element 71 from the horizontal scanning angle detection signal 73. Then, the general control unit 10 controls the operation of the signal processing circuit 21, based on the received signal. The signal processing circuit 21 supplies the horizontal driving signal 23 to the horizontal scanning control circuit 72 and the vertical driving signal 24 to the vertical scanning control circuit 82. The horizontal scanning control circuit 72 controls the movement of the resonance-type deflection element 71, based on the supplied horizontal driving signal 23. The vertical scanning control circuit 82 controls the movement of the deflection element 81, based on the supplied vertical driving signal 24. By the above process, the horizontal scanning and the vertical scanning are synchronized.

[Operation Control of HMD]

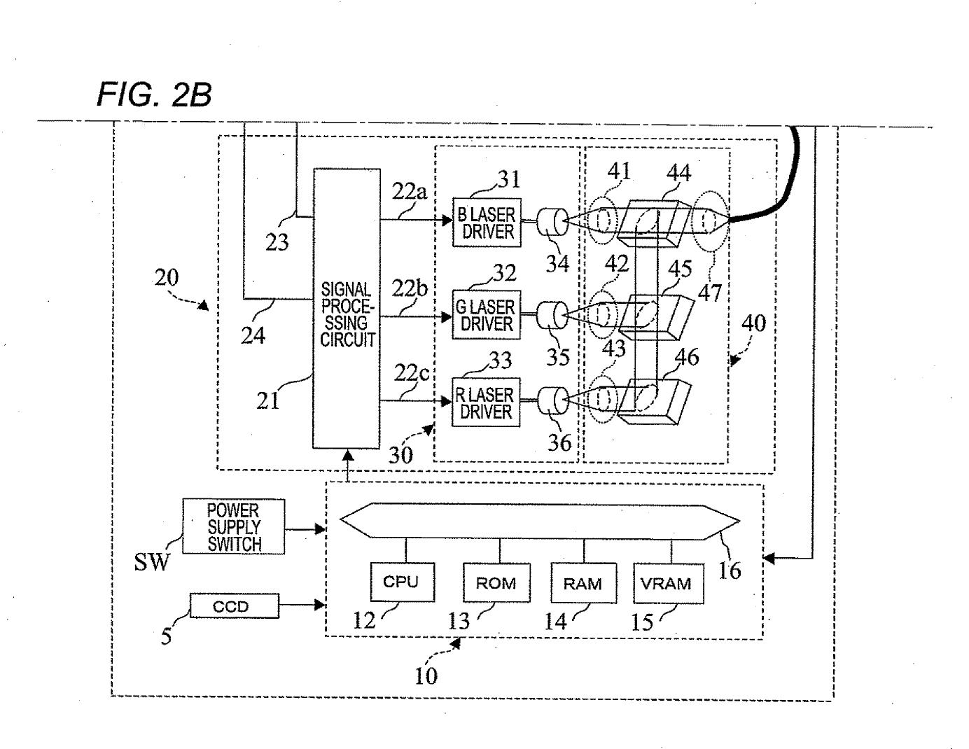

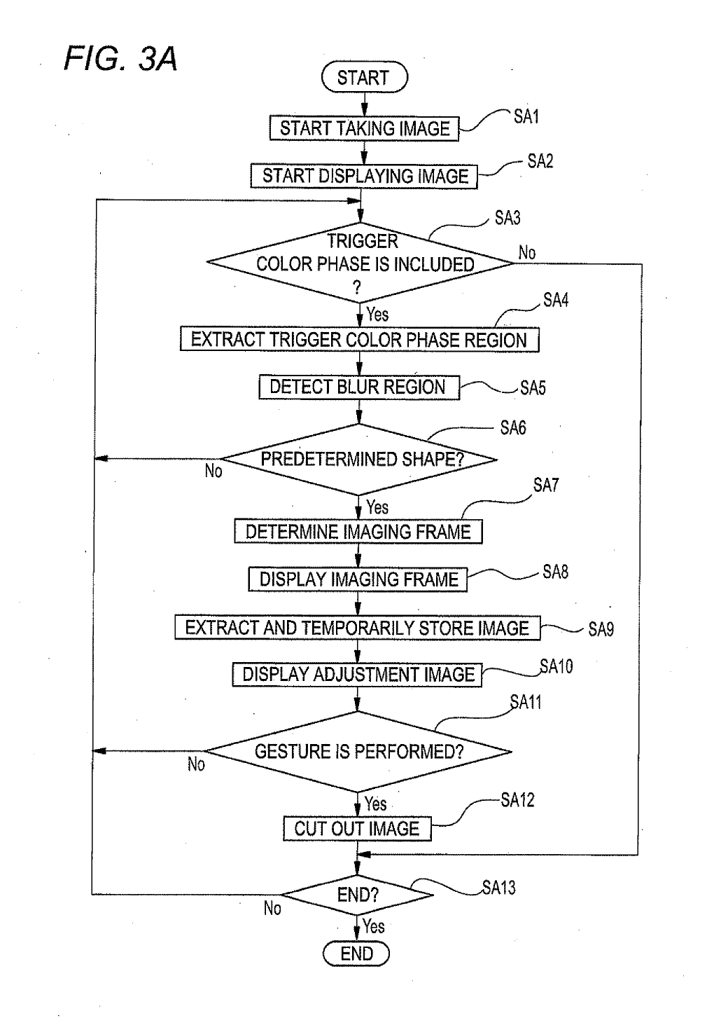

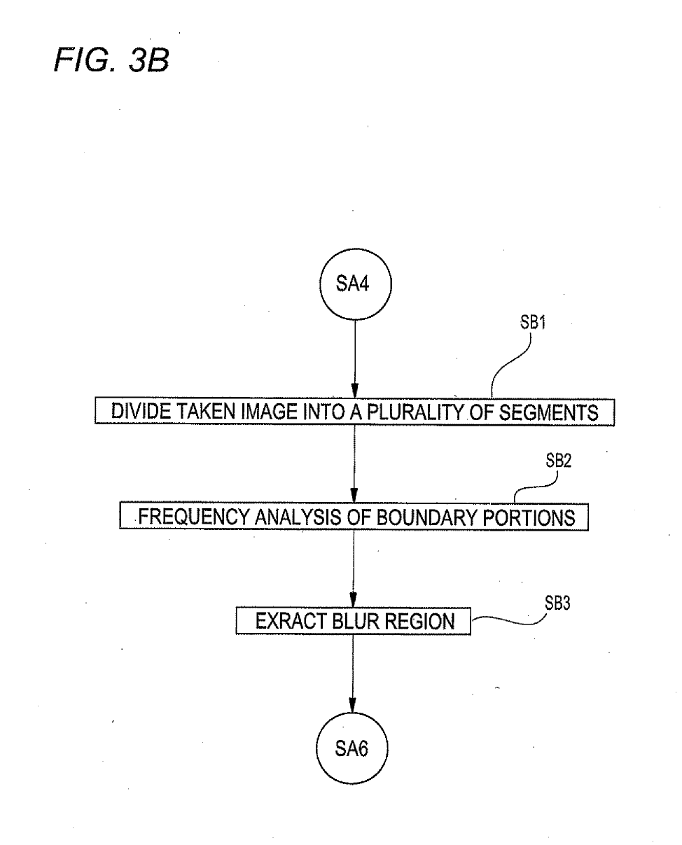

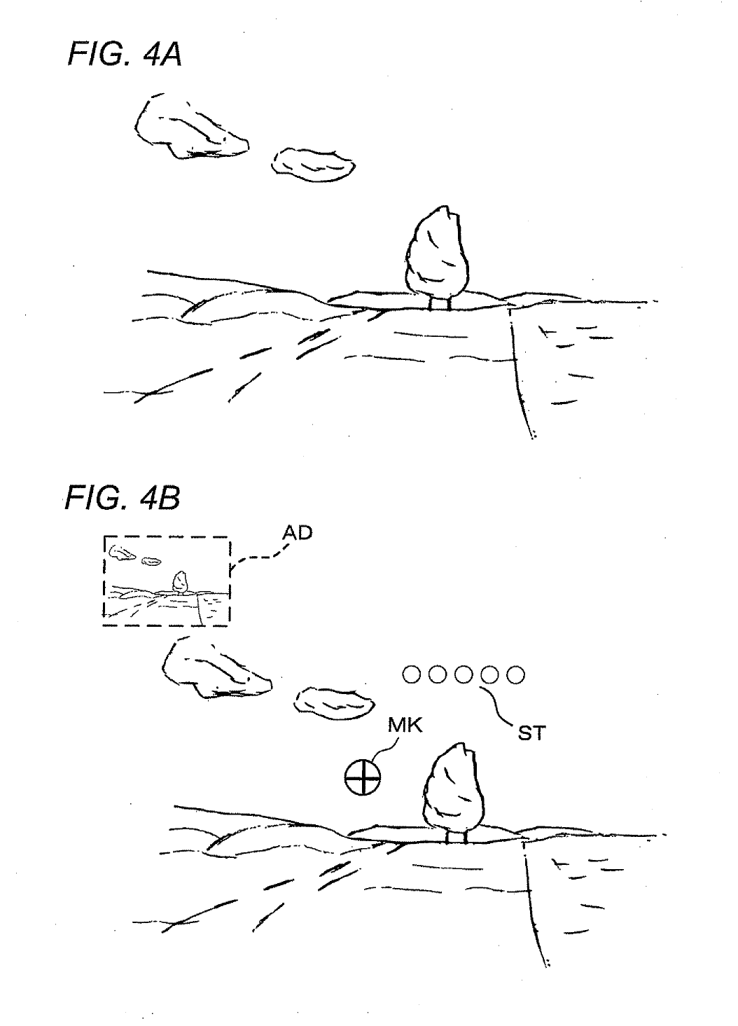

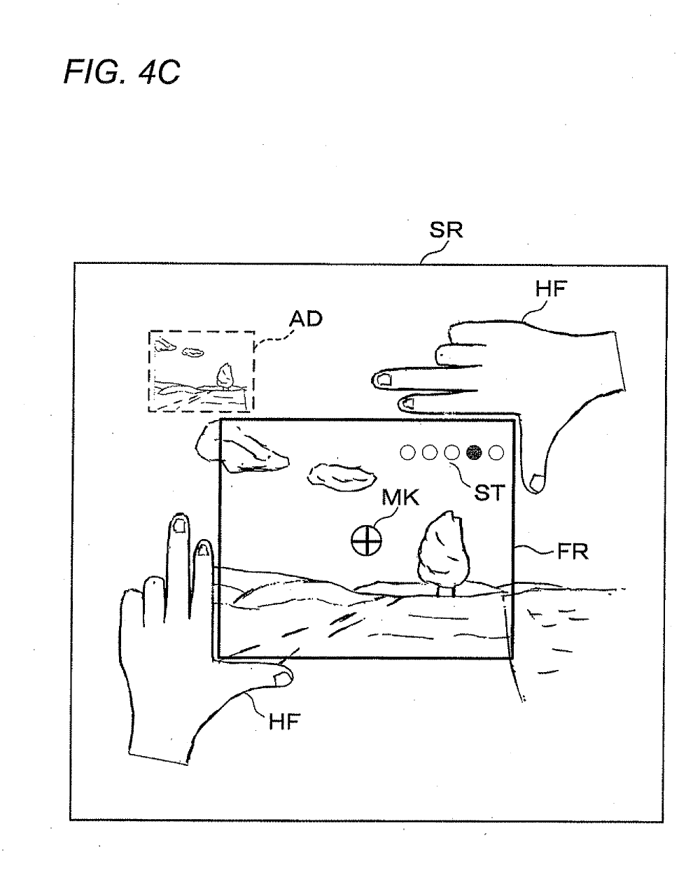

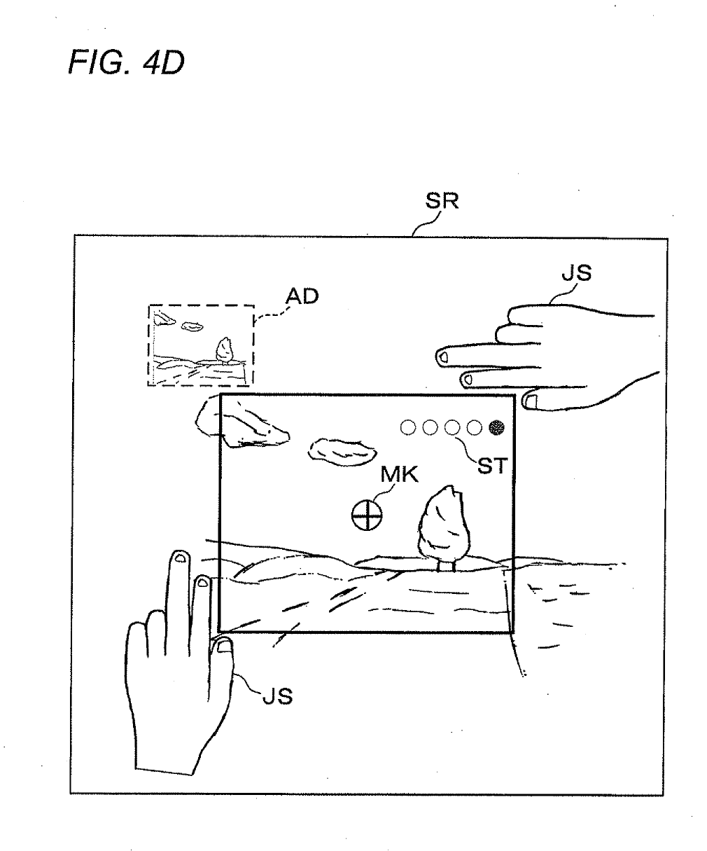

In the below, the operation control of the HMD 1 is described with reference to FIGS. 3A to 3B and 4A to 4D.

FIG. 3A is a flow chart showing the operation control of the HMD 1. A series of operation controls are executed by the CPU 12. The CCD 5 takes an outside scene shown in FIG. 4A. At the same time, the outside scene shown in FIG. 4A is visually recognized by the user P.

In the process shown in FIG. 3A, the CCD 5 starts taking an outside scene image (SA1).

When the taking the outside scene image is started, the taken outside scene image is supplied from the CCD 5 to the general control unit 10, so that a content image is displayed (SA2). The content image that is displayed in SA2 includes a marker image MK, an adjustment image AD and an imaging state image ST.

The marker image MK is an image for notifying the user P of a focus position of the CCD 5. The marker image MK is pre-stored in the ROM 13 and is read out and displayed by the CPU 12.

As shown in FIG. 4B, the adjustment image AD is a reduced image of an image within the imaging frame and is displayed at a left upper end in a display range. The adjustment image AD is provided such that the user P can check whether an image is cut out as the user wishes and finely adjust the imaging frame. At an initial state, i.e., at a state in which an image is not cut out yet, an image that is being taken by the CCD 5 is displayed as the adjustment image AD, as shown in FIG. 4B.

The imaging state image ST is an image that is provided for the user P so as to indicate which step of the image taking process the HMD 1 gets into, during the image taking process. As shown in FIG. 4B, the imaging state image ST is configured by five circle marks. When the HMD gets into any one step of the image taking process that will be described later, a corresponding circle mark lights on in red. At the initial state, since the HMD does not get into any step of the image taking process, no circle mark lights up, as shown in FIG. 4B.

When the content image is displayed, it is determined whether a trigger color phase CL pre-stored in the ROM 13 is included in the outside scene image taken by the CCD 5 (SA3). The trigger color phase CL indicates a color phase that is pre-stored in the ROM 13 as a color phase of a finger of the user P. The trigger color phase CL is one of conditions with which an image is cut out.

When it is determined that the trigger color phase CL is included in the outside scene image (SA3: Yes), a region having the trigger color phase CL is extracted from the outside scene taken by the CCD 5 (SA4).

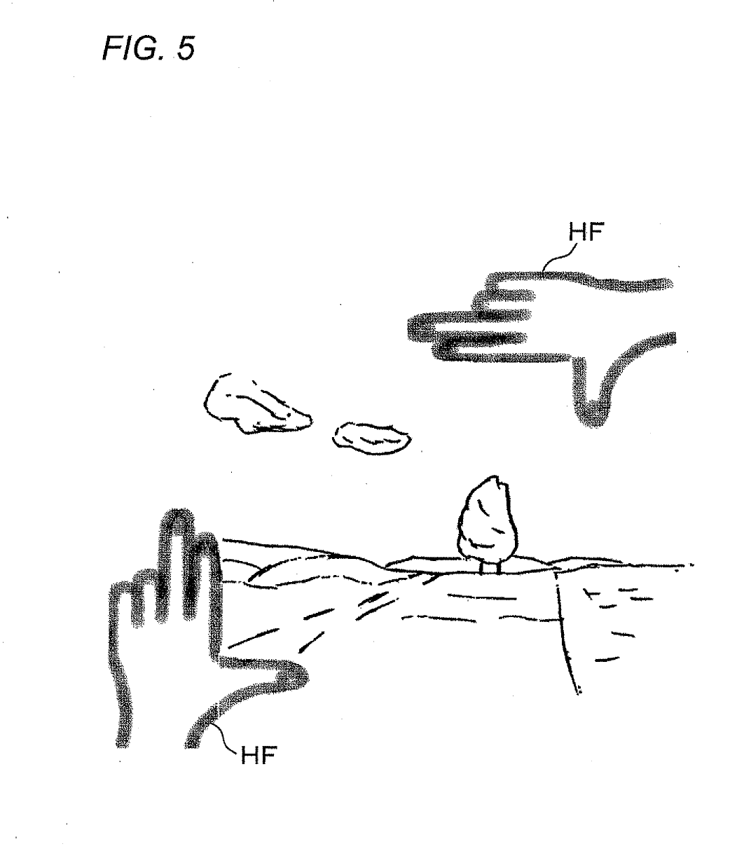

When the region having the trigger color phase CL is extracted, a blur region is extracted according to a flow chart shown in FIG. 3B (SA5). The blur region indicates a region that is taken by the CCD 5 with an image being blurred in the imaging range SR shown in FIG. 4C because the image is distant from the focus position. In SA5, a boundary of the region having the trigger color phase CL, which is recognized in SA4, in the blur region is finally extracted. That is, as shown in FIG. 5, an image of the finger HF of the user P, which is blurred, is extracted.

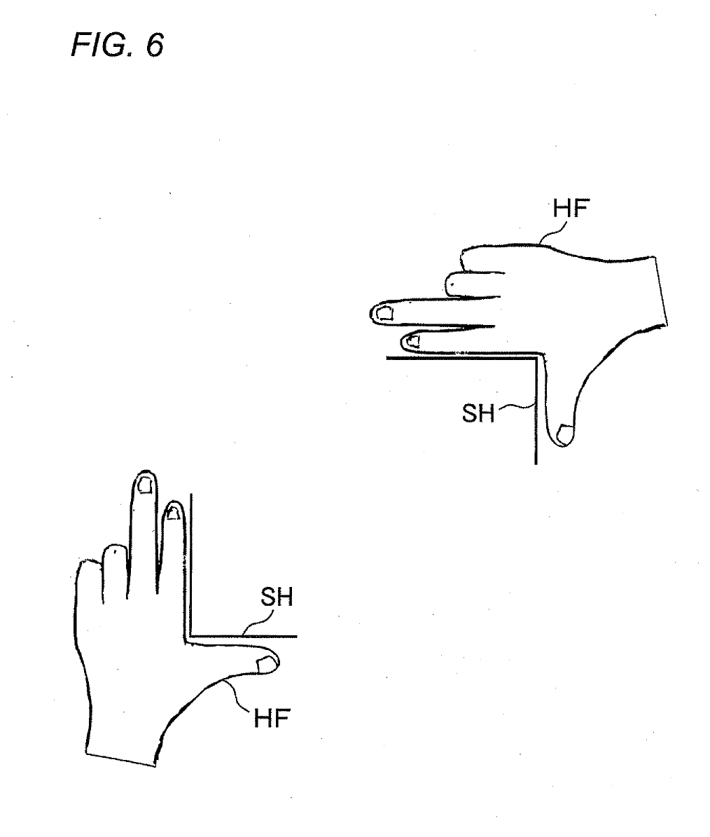

When the blur region is extracted, it is determined whether any of the boundary portions of the region having the trigger color phase CL recognized in SA4 in the blur region substantially matches a predetermined shape SH stored in the ROM 13 (SA6). The predetermined shape SH is a pair of L shapes opposed to each other, each of which is formed by a thumb and an index finger of the user P, as shown in FIG. 6. When it is determined that any of boundary portions of the region having the trigger color phase CL recognized in SA4 does not match the predetermined shape SH (SA6: No), the process returns to SA3 and it is determined whether the trigger color phase CL is included in the outside scene image.

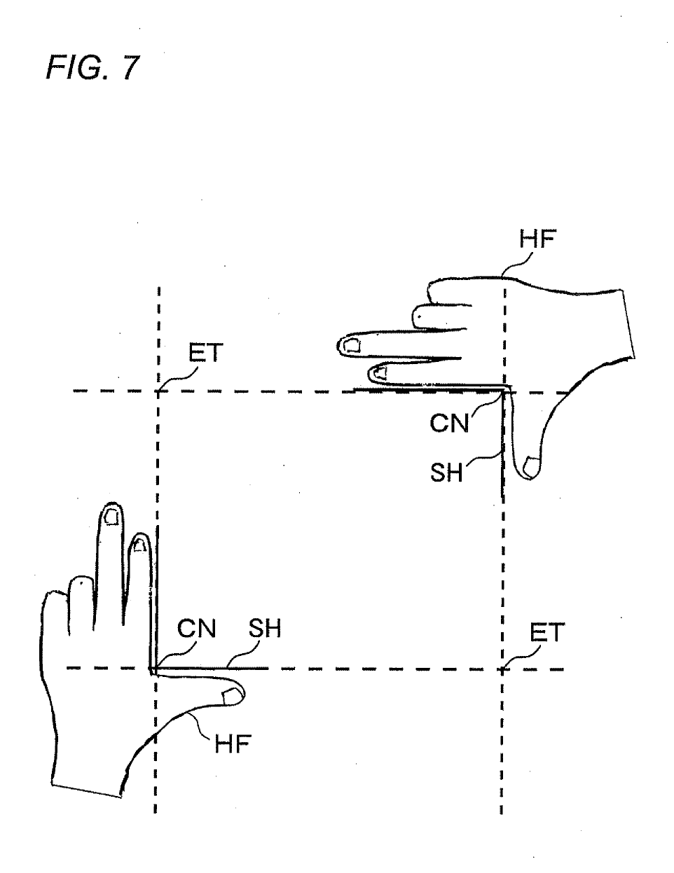

When it is determined that any of the boundary portions of the region having the trigger color phase CL recognized in SA4 in the blur region substantially matches the predetermined shape SH (SA6: Yes), an imaging frame FR indicating a range from which an image will be cut out (extracted) is determined based on the portion that is determined to substantially match the predetermined shape SH in SA6 (SA7). Specifically, as shown in FIG. 7, a rectangular frame, which has two corners CN of the predetermined shape SH and two intersection points ET formed by extending sides of the predetermined shape SH, is determined as the imaging frame FR.

When the imaging frame FR is determined, the imaging frame FR is displayed (SA8), as shown in FIG. 4C.

When the imaging frame FR is displayed, an image within the imaging frame FR is extracted and is temporarily stored in the RAM 14 (SA9). When the image is temporarily stored, the stored image is read out and is drawn one time in the VRAM 15. Then, as shown in FIG. 4C, the image is displayed as the adjustment image AD (SA10).

When the adjustment image AD is displayed, it is determined whether a predetermined gesture JS stored in the ROM 13 is performed (SA11). The predetermined gesture JS is a gesture of moving the thumb closer to the index finger in the imaging range SR of the CCD 5, which have been distant from each other so as to form the L shapes. That is, this gesture JS has a meaning of an instruction to “cut out” the image in the imaging frame FR. SA11 is executed by performing the extraction of the trigger color phase region, the detection of the blur region and the determination of whether or not a gesture has a predetermined shape according to the similar sequences to SA3 to SA6. When it is determined that the predetermined gesture JS stored in the ROM 13 is not performed (SA11: No), the process returns to SA3.

When it is determined that the predetermined gesture JS is performed (SA11: Yes), the image in the imaging frame FR is cut out (SA12). Specifically, the image in the imaging frame FR is extracted and stored in the RAM 14.

When the image is cut out, it is determined whether an instruction of power supply OFF is input from the power supply switch SW (SA13). When it is determined that an instruction of power supply OFF is not input (SA13: No), the process returns to SA3. When it is determined that an instruction of power supply OFF is input (SA13: Yes), the process ends. In the meantime, when it is determined in SA3 that a trigger color phase CL is not included in the outside scene image (SA3: No), the process proceeds to SA13 and determines whether an instruction of power supply OFF is input from the power supply switch SW. As described above, according to this illustrative embodiment, the imaging frame FR is easily determined, so that an image within the imaging frame FR can be cut out. Accordingly, the user P can easily take only an image in a part to be noted and store the same in the HMD 1. In addition, after the imaging, it is not necessary for the user P to perform a trimming process and the like. Also, since only an image in the part to be noted is stored, an extra part in the outside scene is not taken, so that the user P can save the storage capacity of the HMD 1.

In the meantime, whenever the process proceeds to any one step of SA3, SA5, SA6, SA7 and SA12, it is detected that the image taking process corresponding to each step is being executed and the circle mark of the imaging state image ST corresponding to each step of the image taking process lights up in red.

In the below, the process of extracting the blur region in SA5 is described with reference to FIG. 3B. In the process shown in FIG. 3B, the outside scene image taken by the CCD 5 is divided into a plurality of segments (SB1). Among the divided segments, a frequency analysis is performed for segments including the region having the trigger color phase CL extracted in SA4, a background region, which is a region of the outside scene image having no trigger color phase CL, and a boundary of the region having the trigger color phase CL (SB2).

When the frequency analysis is performed, among the segments for which the frequency analysis is performed, segments that include a space frequency component equal to or smaller than a predetermined space frequency FQ stored in the ROM 13 are gathered and extracted (SB3). Here, the space frequency FQ indicates the number of repetition times of a shading change per a unit length of an image. In SB3, a boundary of the region having the trigger color phase CL recognized in SA4 in the blur region is finally extracted. In this step, a known frequency analysis technique of using the Fourier transformation and the like, which is disclosed in JP 9-15506A, can be used.

When SB3 is performed, the process of extracting the blur region ends. Then, the process returns to SA6 of the main process shown in FIG. 3A.

### Second Illustrative Embodiment

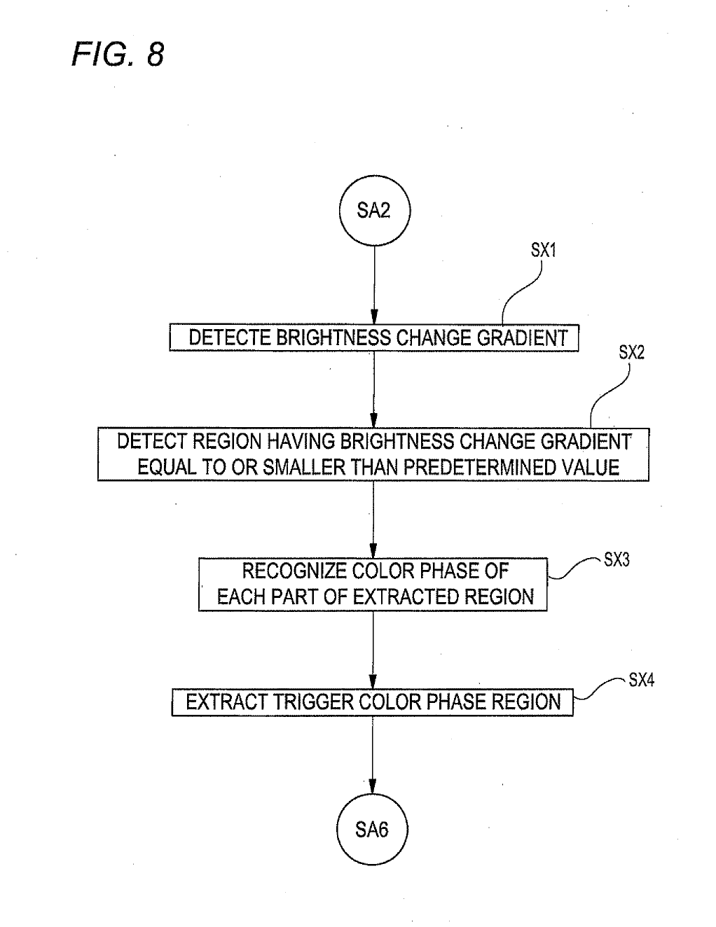

A second illustrative embodiment of this disclosure is described with reference to the drawings. In the first illustrative embodiment, the recognition of the trigger color phase CL and the extraction of the blur region are performed in order of SA3 to SA5 shown in FIG. 3A. However, the process is not limited thereto, and may be performed as shown in FIG. 8. In the second illustrative embodiment, the same configurations as the first illustrative embodiment are indicated with the same reference numerals.

In the process shown in FIG. 8, a brightness change gradient detection is performed for the outside scene image taken by the CCD 5, by Sobel operator that is a widely used edge extraction method, and the like.

When the brightness change gradient detection is performed, a region having a brightness change gradient, which is equal to or smaller than a predetermined value GR stored in the ROM 13, is extracted (SX2). That is, in SX2, a region of the image that is blurred is extracted.

When SX2 is performed, color phases of respective parts of the region extracted in SX2 are recognized (SX3).

When SX3 is performed, a part of the region extracted in SX2, which has the trigger color phase CL stored in the ROM 13 is extracted (SX4).

When SX4 is performed, the process shown in FIG. 8 ends. Then, the process returns to SA6 of the main process shown in FIG. 3A.

In this illustrative embodiment, the blurred image is recognized based on the brightness change gradient of the taken image. Since the region having the brightness change gradient equal to or smaller than the predetermined value corresponds to a region having the space frequency characteristic which does not have high frequency component, the extraction of the region having the brightness change gradient equal to or smaller than the predetermined value is an example of the extraction of a part of an image having low space frequency.

### Modified Illustrative Embodiments

In the above illustrative embodiments, the trigger color phase CL is stored beforehand in the ROM 13. However, for example, the trigger color phase CL may be set by imaging a finger of the user P in advance before SA3 shown in FIG. 3A and then detecting a color phase of the imaged finger of the user P. In this case, the color phase of the finger of the user P, which is detected as the trigger color phase L, is stored one time in the RAM 14 and is read out when it is determined whether the trigger color phase CL is included in the outside scene image taken by the CCD 5 in SA3.

In the above illustrative embodiments, the HMD 1 is a retina scanning display. However, for example, the HMD 1 may be a head-mounted display apparatus in which an LCD display panel and the like is used.

In the above illustrative embodiments, one-eye model has been described in which the content image is displayed for the left eye of the user P. However, both-eye model may be used.

In the above illustrative embodiments, the adjustment image AD is displayed at the left upper end of the display range. However, for example, the adjustment image may be displayed at a left lower end, right upper and lower ends or near a center part of the display range.

In the above illustrative embodiments, the predetermined shape SH is a pair of L shapes opposed to each other. However, the predetermined shape may be circular or square. When the predetermined shape is circular or square, the user P may form the predetermined shape SH by facing the respective fingers of the left and right hands each other.

In the above illustrative embodiments, a gesture having the meaning of “cutting out” the image in the imaging frame FR is the predetermined gesture JS. However, for example, the voice of “cutting out” spoken by the user P may be used. In this ease, the HMD 1 may be configured so as to include a voice recognition unit and configured such that the CPU 12 recognizes the voice of “cutting out” spoken by the user P.

In the above illustrative embodiments, a zoom function of a camera has not been described. However, the zoom function may be provided to the lens unit of the CCD 5. In the above illustrative embodiments, the blurred image is possibly included in the imaging frame FR. However, in the configuration of having the zoom function, after the imaging frame FR is determined, the blurred image in the imaging frame FR may be zoomed in by the zoom function until the blurred image gets out beyond the imaging frame FR. Also, when a blur region having the trigger color phase CL is not included in the outside scene image taken by the CCD 5, the lens unit may be wide-angled such that the finger of the user P or the blur region gets in the imaging range SR.

What is claimed is:

1. A head-mounted display apparatus which is mountable around a head of a user and which is configured to allow the user to visually recognize an information image based on image light generated from image information together with an outside scene image based on outside light, the head-mounted display apparatus comprising:
an imaging unit configured to take the outside scene image based on the outside light;
a low frequency region extraction unit configured to extract, from the outside scene image, a low frequency region having a space frequency characteristics which has a space frequency component equal to or smaller than a predetermined space frequency;
a color phase recognition unit configured to recognize a predetermined color phase in the outside scene image taken by the imaging unit;
an imaging frame determination unit configured to determine an imaging frame indicating an image cutout range, based on an image portion which has the predetermined color phase recognized by the color phase recognition unit and has a predetermined shape, within the low frequency region extracted by the low frequency region extraction unit; and
an image extraction unit configured to extract an image within the imaging frame determined by the imaging frame determination unit from the outside scene image taken by the imaging unit, and store the extracted image.

2. The head-mounted display apparatus according to claim 1,
wherein the low frequency region extraction unit is configured to extract a region of the outside scene image, which has a brightness change gradient equal to or smaller than a predetermined value, as the low frequency region.

3. The head-mounted display apparatus according to claim 1, further comprising:
a marker generation unit configured to generate a marker image indicating a focus position of the imaging unit,
wherein the marker image is displayed to be visually recognizable by the user together with the information image and the outside scene image.

4. The head-mounted display apparatus according to claim 1, further comprising:
an imaging frame image generation unit configured to generate an image of the imaging frame determined by the imaging frame determination unit,
wherein the image of the imaging frame is displayed to be visually recognizable by the user together with the information image and the outside scene image.

5. The head-mounted display apparatus according to claim 1, further comprising:
an extraction image generation unit configured to read out and generate the image extracted and stored by the image extraction unit,
wherein the image within the imaging frame, which is generated by the extraction image generation unit, is displayed to be visually recognizable by the user together with the outside scene image.

6. The head-mounted display apparatus according to claim 1, further comprising:
an operation state detection unit configured to detect which one of the low frequency region extraction unit, the color phase recognition unit, the imaging frame determination unit and the image extraction unit operates, and
an operation information generation unit configured to generate operation information indicating an operation state according to a detection result of the operation state detection unit,
wherein an image indicating the operation information generated by the operation information generation unit is displayed to be visually recognizable by the user together with the outside scene image.

7. An image control method for a head-mounted display apparatus mountable around a head of a user and configured to allow the user to visually recognize an information image based on image light generated from image information together with an outside scene image based on outside light, the method comprising:
taking the outside scene image;
extracting, from the taken outside scene image, a low frequency region having a space frequency characteristics which has a space frequency component equal to or smaller than a predetermined space frequency;
recognizing a predetermined color phase in the taken outside scene image;
determining an imaging frame indicating an image cutout range, based on an image portion which has the predetermined color phase and has a predetermined shape, within the extracted low frequency region; and
extracting an image within the determined imaging frame from the taken outside scene image, and storing the extracted image.

8. A non-transitory computer-readable medium having a computer program stored thereon and readable by a computer included in a head-mounted display apparatus mountable around a head of a user and configured to allow the user to visually recognize an information image based on image light generated from image information together with an outside scene image based on outside light, the computer program, when executed by the computer, causing the computer to perform operations comprising:
taking the outside scene image;
extracting, from the taken outside scene image, a low frequency region having a space frequency characteristics which has a space frequency component equal to or smaller than a predetermined space frequency;
recognizing a predetermined color phase in the taken outside scene image;
determining an imaging frame indicating an image cutout range, based on an image portion which has the predetermined color phase and has a predetermined shape, within the extracted low frequency region; and
extracting an image within the determined imaging frame from the taken outside scene image, and storing the extracted image.
